(19) United States
(12) Patent Application Publication
(10) Pub. No.: US 2006/0001568 A1
(43) Pub. Date: Jan. 5, 2006

(54) Method and apparatus for providing an electronic warfare target simulator

(75) Inventors: Geoffrey Lawrence Alford, Canberra (AU); Kathryn Maureen Devoy, Canberra (AU)

Correspondence Address: c/- Viktoria Gaw, 2561 Verbena Drive, Hollywood, CA, 90068, US

(73) Assignees: Compucat Research Pty Limited, Belconnen (AU); Geoffrey Lawrence Alford, Chisholm (AU)

(21) Appl. No.: 10/916,382

(22) Filed: Aug. 11, 2004

(30) Foreign Application Priority Data
Aug. 21, 2003 (AU) 2003904482

(51) Int. Cl. G01S 7/40

(52) U.S. Cl. 342/169; 342/13; 342/170

(57) ABSTRACT

An electronic warfare target simulator is a small, low power, programmable target simulator for Defence electronic warfare operators to use for training in Electronic Warfare deception and jamming techniques and to aid in the calibration of radio direction finding equipment. The invention includes methods and apparatus for the replay of stored data and the generation of electronic noise or tones to be transmitted in open air to deceive or jam target receiving intercept electronic warfare operators and their equipment.

### BACKGROUND OF THE INVENTION

1. Field of the Invention

This invention relates to the simulation of a target communications emitter and provides both a method and apparatus for the training of Electronic Warfare and Communications Operators of the Armed Forces.

2. Description of the Related Art

Electronic warfare is an integral component of Armed Forces doctrine for the majority of warfighting divisions in the battlespace. Effective training of Electronic Warfare and generic Communications Operators is therefore critical to the successful completion of military operations.

There are known electronic warfare simulators used for this training. In the vast majority of cases these simulators are very large, truck/van mounted or laboratory style systems. They are dependent on vast amounts of power and the interconnectivity of adversary and friendly target emitters to allow for the exact replication of the effects of electronic warfare on known communications systems. Additionally, these systems are best used in closed or classroom environments where they can be protected. The fact that these systems friendly and adversary replications are physically joined means that the training is not realistic. Hitherto the art was complex and simplifying this type of device was avoided.

Electronic deception involves the art of duping or spoofing electronic sensors and/or operators into believing that a target is geolocated at a point that the real target has either vacated or indeed was never at. Another form of electronic deception involves the delivery of incorrect information or intelligence to the receiving unit. This information distracts the Electronic Warfare operators from their set task whilst slowing the intelligence dissemination process to such a degree that the delivery of intelligence is either greatly delayed or in some cases stopped owing to injected confusion.

Electronic Warfare operators, in the communications arena, are tasked with collecting intelligence from targeted radio emitters. This is done by the transcription of target voice channels or the analysis of more technical data channels. By injecting spurious tones and voice transmissions to either of the aforementioned mediums, the deception device produces the requirement for extra analysis, translation or transcription with the net result of drastically slowing the intelligence collection process. The subsequent confusion is both difficult to manage and also takes Electronic Warfare operators away from their set task thus giving the deceiver an advantage in warfare.

When gaining confidence in and verifying the serviceability of radio direction finding equipment, it is necessary to provide a radio emitter as a target for the subject equipment to operate against. Currently, this is provided by a communications operator or detachment, using communications equipment in its standard configuration. This removes the operators or detachment from normal duty and therefore wastes valuable time for those personnel.

Electronic warfare jamming systems are well known and in some cases used when a target emitter is required to be taken off the air. The jamming signal may render intended communications received by the victim communications system unintelligible or may merely cause distracting interference. The end result is disruption to the target's communications. This type of communications jamming is provided by large, high power, automatic or semi-automatic jamming systems. These systems must be manned and placed forward of the Forward Line of Own Troops (FLOT) to allow the jammer to have the desired affect. To enable safety of the crew these jammers are best built into armoured vehicles and are highly mobile.

All of the systems mentioned have included the necessity of highly complex and protected systems with the added burden of vehicle and manpower intense requirements.

Some former Soviet block nations produce a 152 mm Artillery deliverable system, the “Strushell” that provides a limited capability of providing tones for nuisance VHF communications jamming during an Artillery Barrage, recognised in the art as being the most valuable time to jam target communications. This system requires a large field Artillery piece for delivery and its carrier shell must be fired from aforesaid Artillery piece to initiate its operation. There is no known similar device produced by Western or allied countries.

The present invention recognises the need for a singular, small, low cost, programmable, low power device that can be set to operate independently, at given times or constantly, be considered as disposable yet requires very low manpower requirements for both its delivery and operation. Various reasons exist as to why a simplified device of the present invention has not been created before. Typically, large organisations have declined from providing such a low cost device as these devices have previously been determined to not necessarily provide for a high revenue return. Additionally, despite the inclusion of this style of device, typified as an Unattended Jammer (UAJ) in Armed Force doctrine, military units have preferred to employ more technical and manpower intensive systems. This is because this equipment is the main Electronic Warfare purchased by governmental agencies.

### SUMMARY OF THE INVENTION

The invention is a simple, small, low power, programmable target simulator for Armed Forces Electronic Warfare operators to use for training in and for operations on Electronic Warfare deception and jamming techniques and to aid in the calibration of radio direction finding equipment. The invention includes methods and apparatus for the replay of stored data and the generation of electronic noise or tones to be transmitted in open air to deceive or jam target receiving intercept electronic warfare operators and their equipment.

The system comprises a method of generating and transmitting a radio frequency signal which contains recorded information to confuse targeted receivers or transmitting a pre-set tone or a set of tones on a radio frequency to emulate radio frequency activity in a location.

The electronic warfare target simulator comprises:
a means for storing pre-recorded communications signals,
audio recording for recording user signals,
generation of one or more signals,
a radio frequency transmitter with an antenna,
user controls, and
a connected microprocessor to control the transmission of pre-recorded communications signals, user or tone signals according to pre-programmed software scheduling via user controls.

In the preferred embodiment of the present invention, the electronic warfare target simulator consists of five main components: the Audio Section, the Microprocessor and peripherals, memory, real time clock, the RF Transmitter, the power supply and the Antenna

### DESCRIPTION OF THE PREFERRED EMBODIMENT

In its preferred embodiment:
The unit is one man-portable, a single module, totally self contained and housed in a weatherproof enclosure.
Power is provided by rechargeable batteries and may also be powered using a step down transformer from AC mains.
The frequency range of the invention is in the communications bands.
The target modulation includes tone generation. Sound recordings are loaded via a line in adaptor or via direct sound recording from an in built microphone. White noise and null tone can also be transmitted.
A number of different tracks are recorded with a pre-determined maximum duration.
The antenna is omni-directional with associated ground plane and counterpoise.
The system is software programmable to enable differing modulation types or recorded information to be played at varying times on varying frequencies. The user has a choice of programmable variations. Programming is carried out using a digital communication interface via the configuration interface.

### BRIEF DESCRIPTION OF THE DRAWING FIGURES

The present invention is illustrated in the attached figure:

FIG. 1 is a simple equipment block diagram of an exemplary embodiment of the electronic warfare target simulator according to the present invention

FIGS. 2, 3, 4, 5 and 6 are the software schema flow chart for the purpose of controlling the electronic warfare target simulator. These Figures are connected in the following manner:
FIG. 2, is the first part of the flow chart. Lines 1 and 2 of FIG. 2 lead to Lines 1 and 2 of FIG. 3. Lines 3 and 4 of FIG. 2, lead to Lines 3 and 4 of FIG. 5.
FIG. 3 receives Lines 1 and 2 from FIG. 2. FIG. 3 Lines 1a and 2a lead to Lines 1a and 2a of FIG. 4.
FIG. 4 receives Lines 1a and 2a from FIG. 3.
FIG. 5 receives Lines 3 and 4 from FIG. 2. Lines 3a and 4a of FIG. 5 lead to Lines 3a and 4a of FIG. 6.
FIG. 6, is the last part of the flow chart and receives Lines 3a and 4a from FIG. 5.

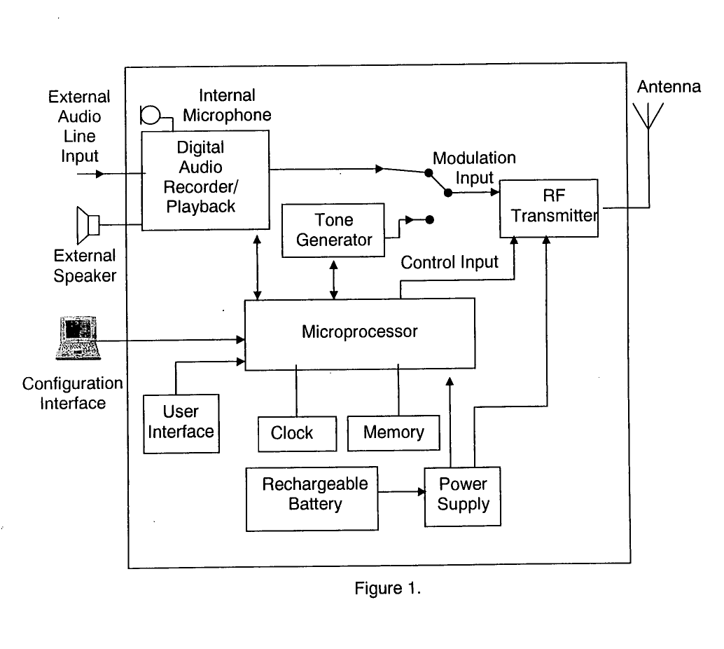

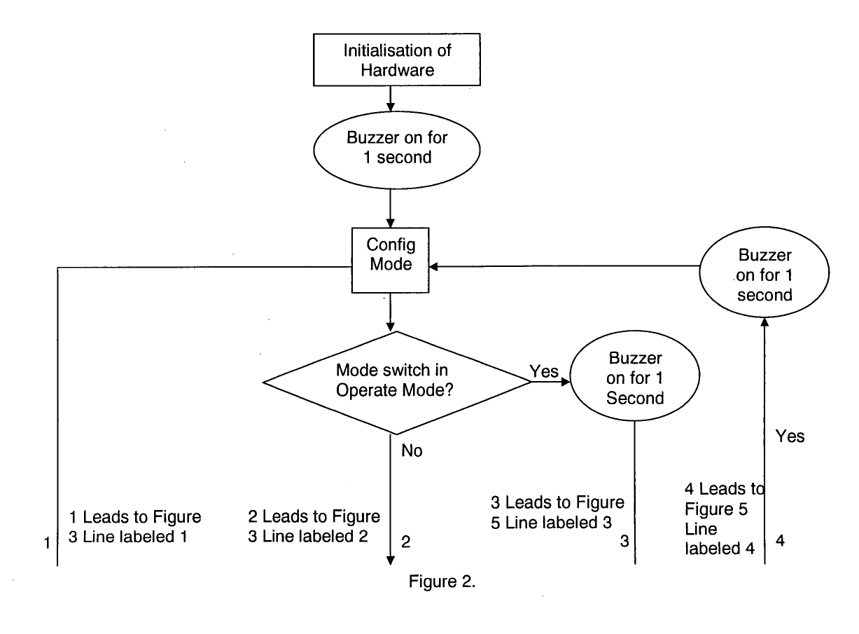

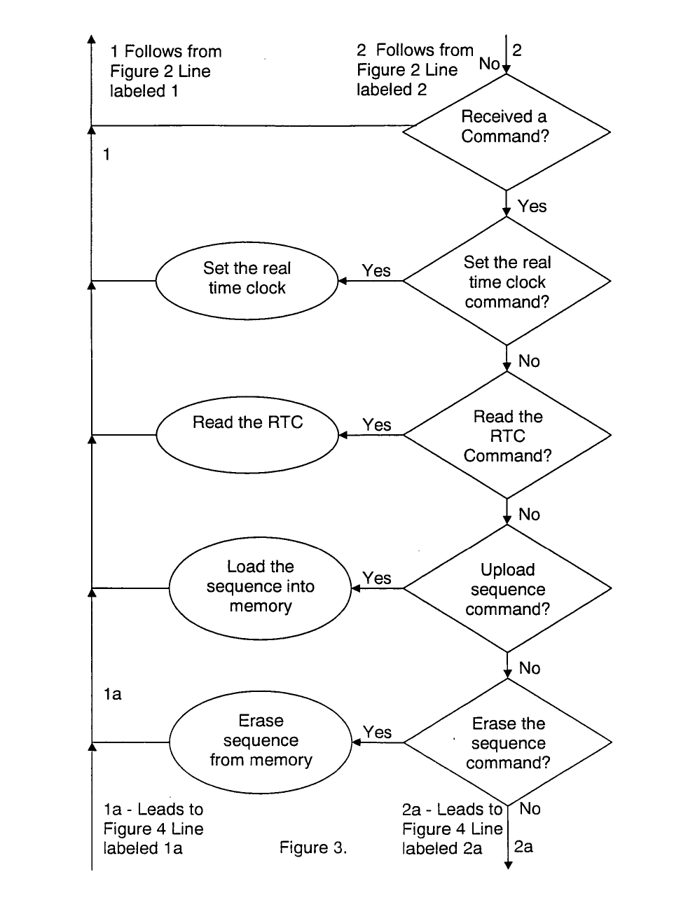

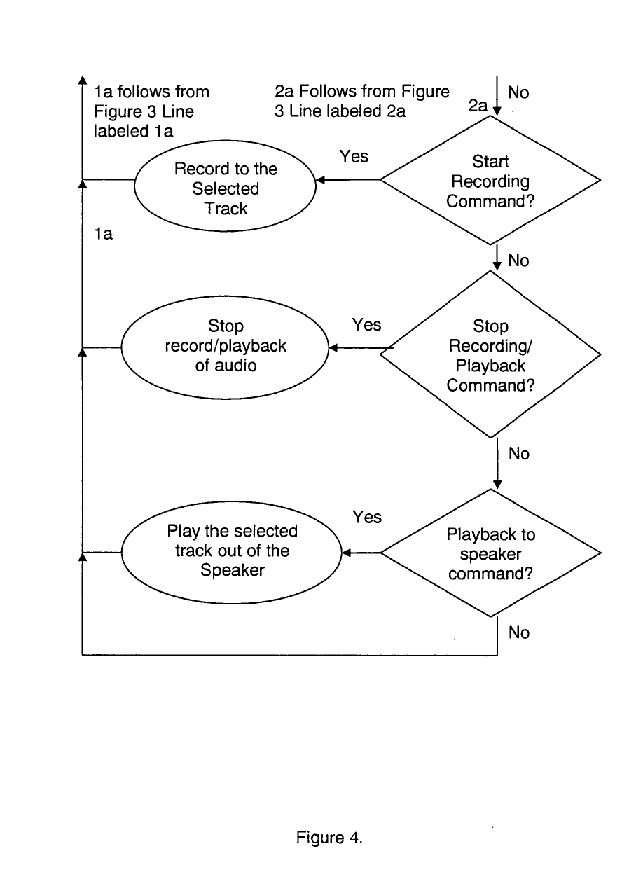

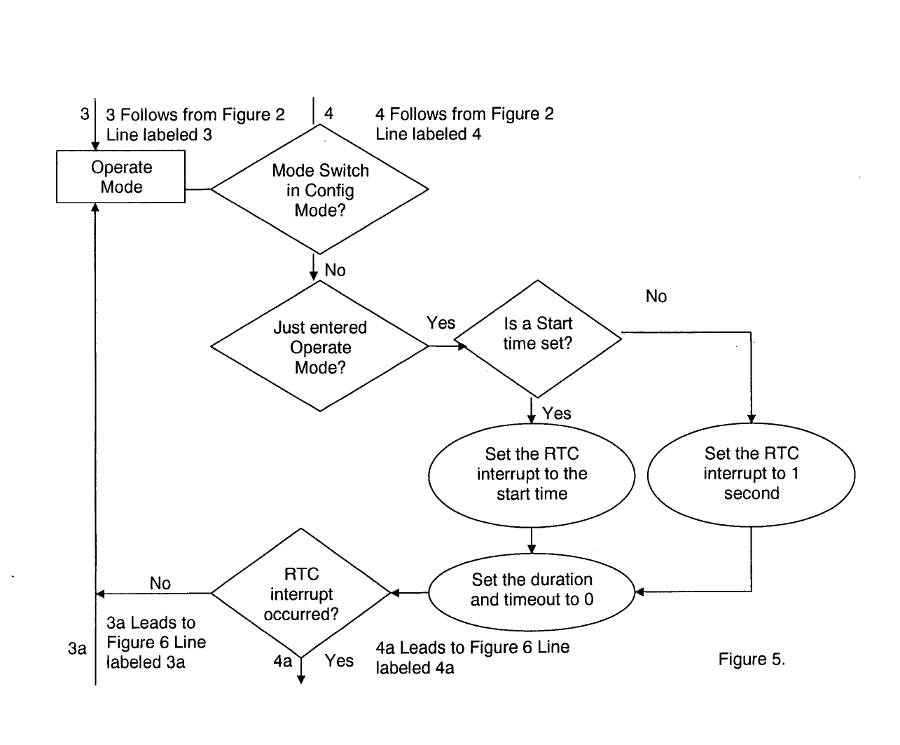

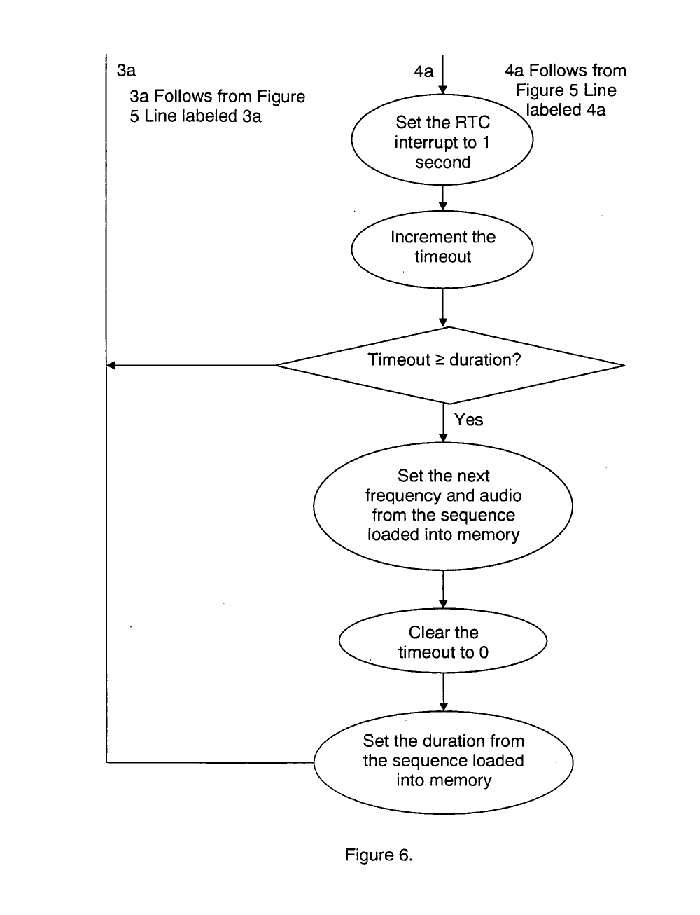

### DETAILED DESCRIPTION OF THE INVENTION

The audio for transmission is recorded onto an integrate circuit. The audio source for the recording can be from either the internal microphone or from a pre-recorded source entered through the external connector. The playback from the IC can be confirmed using the external speaker/headphone output. A separate IC performs tone generation to simulate telephone, modem and musical tones. This also can be used as audio for transmission.

The software used to control the electronic warfare target simulator provides a user interface to provide manipulation of stored information in the memory. This leads to the ability for the user to produce any possible combination of frequency, modulation and timing to create a signal suitable to create confusion in the target communications intelligence collection system.

The microprocessor controls the interface to the tone generator IC and the audio recording/playback system. A real time clock and non-volatile memory are also connected to the microprocessor. The real time clock is used for real time transmission timing and the non volatile memory is used for storing transmission data. The user interface is through digital communications port on the microprocessor. Commands can be sent over the digital communications interface from a PC or other controlling device to setup transmission frequencies, duration of transmissions, the day and time transmissions commence and what audio is transmitted. All of this is stored in the non-volatile memory. The microprocessor is also used to control the RF transmitter.

The RF transmitter can be frequency or amplitude modulated by the audio source. This is determined by hardware configuration. The tone generator or the record/playback system is switched into the modulator depending on what data is held in the non volatile memory. The specific track or tone played also will depend on this data. The RF transmitter is set to the frequency stored in the memory. In the preferred embodiment the frequency range will be VHF and UHF frequency band with a low output power into an antenna. The transmitter can be turned on and off and the transmission data changed in synchronization with the real time clock.

In the preferred embodiment the unit can be powered by any DC power source. This means rechargeable batteries are a possible power source. The power source is split into several supplies. The RF transmitter section, the Audio section and Microprocessor are powered by on board power.

In the preferred embodiment, the user has the choice of one of two omni-directional antennae and/or a ground plane with attached counterpoise. The antenna choices are a short flexible whip optimised for short distance transmission and a longer more rigid whip for longer distance transmission. Both antennae can be used with an optional ground plane with attached counterpoise and are optimised to be used in the VHF communications band.

In the preferred embodiment the resultant signal is transmitted through open air and the received signal at the target receiver will either present itself as a new source of intelligence or as a disruption to normal communications.

What is claimed:

1. A method of deceiving a communications and intelligence collection system, comprising: generating and transmitting a radio frequency signal which comprises recorded information or transmitting a pre-set tone on a radio frequency to emulate radio frequency activity in a location to confuse targeted receivers and intelligence collection systems.

2. A method of deceiving a communications and intelligence collection system as recited in claim 1, further comprising: transmitting a series of radio frequencies with recorded information.

3. A method of deceiving a communications and intelligence collection system as recited in claim 1, wherein said transmissions are scheduled to begin at given dates and times.

4. A method of deceiving a communications and intelligence collection system as recited in claim 1, wherein a combination of both recorded information and pre-set tones is transmitted.

5. A method of deceiving a communications and intelligence collection system as recited in claim 1, wherein pre-set tones are transmitted on a target radio frequency.

6. A method of deceiving a communications system and intelligence collection system as recited in claim 1, wherein a deception signal is produced in the VHF and UHF frequency band.

7. A method of deceiving a communications system and intelligence collection system as recited in claim 1, wherein the scheduling is provided by software.

8. An electronic warfare target simulator comprising: means for generating and transmitting a radio frequency signal which contains recorded information or transmitting a pre-set tone or a set of pre-set tones on a radio frequency to emulate radio frequency activity in a said location to confuse a targeted intelligence collection system.

9. An electronic warfare target simulator as recited in claim 8, further comprising means for transmitting on a programmed series of radio frequencies.

10. An electronic warfare target simulator as recited in claim 8, in which scheduling said transmission to begin at given dates and times is provided by software.

11. An electronic warfare target simulator as recited in claim 8 in which a combination of both recorded information and pre-set tones is transmitted.

12. An electronic warfare target simulator as recited in claim 8, in which pre-set tones are transmitted on radio frequencies used by a target intelligence collection system.

13. An electronic warfare target simulator as recited in claim 8 in which said signals are transmitted in the VHF or UHF frequency band.

14. Electronic warfare target simulator comprising;
a line level input for pre-recorded audio signals,
a microphone,
a digital audio recorder connected to the line level input and the microphone,
a tone generation means,
a radio frequency transmitter for generating a radio frequency signal,
an antenna connected to the radio frequency transmitter for transmitting the radio frequency signal,
a user control input means,
a microprocessor means connected to each of the said means to control the transmission of said pre-recorded communications signals, user signals or tone signals according to pre-programmed software scheduling or said user controls wherein simulated electronic warfare signals are generated and transmitted.

15. The apparatus of claim 14 wherein said microprocessor is controlled by software via digital communications means from a user interface/configuration computer.
